(19) United States
(12) Patent Application Publication
(10) Pub. No.: US 2004/0031367 A1
(43) Pub. Date: Feb. 19, 2004

(54) Compact rotary shears

(76) Inventors: Horst Grafe, Hilchenbach (DE); Matthias Beuter, Bad-Berleburg (DE)

Correspondence Address: Friedrich Kueffner, Suite 910, 317 Madison Avenue, New York, NY, 10017, US

(21) Appl. No.: 10/381,356

(22) PCT Filed: Oct. 26, 2001
(86) PCT No.: PCT/EP01/12377

(30) Foreign Application Priority Data
Nov. 4, 2000 (DE) 100 54 761.3

(51) Int. Cl. B26D 1/24; B23D 19/04

(52) U.S. Cl. 83/498

(57) ABSTRACT

The invention relates to a device for the double-sided edge-trimming of rolled sections and/or metal sheets, using rotary shears and cut-off shears for cutting up the cut-off edge, the cut-off shears being allocated to a respective set of rotary shears and being located below said rotary shears in an offset manner in relation to the line of travel of the product to be edge-trimmed. The device has a respective pair of drive rollers on the feed and discharge side of the rotary shears, each set of rotary shears (2, 2′), each set of cut-off shears (3, 3′) and each pair of drive rollers (4, 4′; 5, 5′) being positioned together on at least one base body (11, 11′). One base body (11, 11′) is fixed and the second base body (11, 11′) can be displaced and subsequently fixed in a setting for different edge-trimming widths of the rolled section and/or metal sheet.

The invention pertains to a device for trimming the two edges of rolled strips and/or sheets with twin edge-trimming shears, each of which has its own shears for cutting the trimmed-off edge strips, these edge strip-cutting shears being installed under the edge-trimming shears in a position offset from the line of travel of the product(s) to be trimmed, the device also comprising a pair of driver rolls, one at the entrance to, the other at the exit from, the twin edge-trimming shears.

Devices of this type are known in practice. The devices known in practice have edge-trimming shears, shears for cutting up the strip which has been trimmed off from the edges, and drivers at the entrance and exit of the edge-trimming shears to guide and transport the sheets or rolled strips. Each of the four functional groups mentioned represents an independent machine. The essential disadvantages of the separate functional groups are that, for example, they occupy a large amount of space, and that there is a relatively long distance between the entrance driver and the exit driver, as a result of which it becomes difficult to handle short sheets. Because of the relatively long distance between the edge-trimming shears and the edge strip-cutting shears, furthermore, the system of edge strip guidance is susceptible to malfunction.

The document DE 37 41 219 A1 describes an edge-trimming system for trimming the longitudinal edges of a rolled strip as it travels. This system has rotating edge-trimming shears and rotating scrap-cutting or edge strip-cutting shears, the two functional groups being combined into a single compact structural unit. The driver rolls are set up separately from this compact structural unit. The disadvantage of the design of the device according to DE 37 41 219 A1 is that it is difficult to handle short sheets.

A process and a system for trimming the edges of sheets by means of long-blade shears, especially curved-blade shears, is known from DE 30 07 931 A1. Here the system is designed so that the long-blade edge-trimming shears and the edge strip-cutting shears can be connected to each other in different ways to change the ratio between the strokes which the two shears perform and also so that the steps by which the drivers advance the strip can be synchronized with the stroke rate of the edge strip-cutting shears.

The conversion of the reciprocating motion into the rotational motion of the drivers, however, involves complicated engineering and can be implemented only at considerable cost.

The invention is based on the task of eliminating the disadvantages indicated above and simultaneously of making a device available which makes it possible to process relatively short sheets.

To accomplish this task it is proposed that each edge-trimming shears, each edge strip-cutting shears, and each pair of driver rolls be combined on at least one base body; that one base body be stationary; and that the second base body be designed so that it can be moved and then fixed in place to accommodate different trimming widths of the rolled strip and/or sheet.

Because the four functional groups are combined on a single base body, a compact unit, which requires only a small amount of space, can be obtained. Because of the short distance between the pair of driver rolls at the entrance and the pair at the exit, it is possible to process relatively short sheets. The short distance between the edge-trimming shears and the edge strip-cutting shears also ensures that the edge strip can be guided reliably.

Advantageous embodiments of the device according to the invention are disclosed in the subclaims.

An exemplary embodiment of the invention is described in the following:

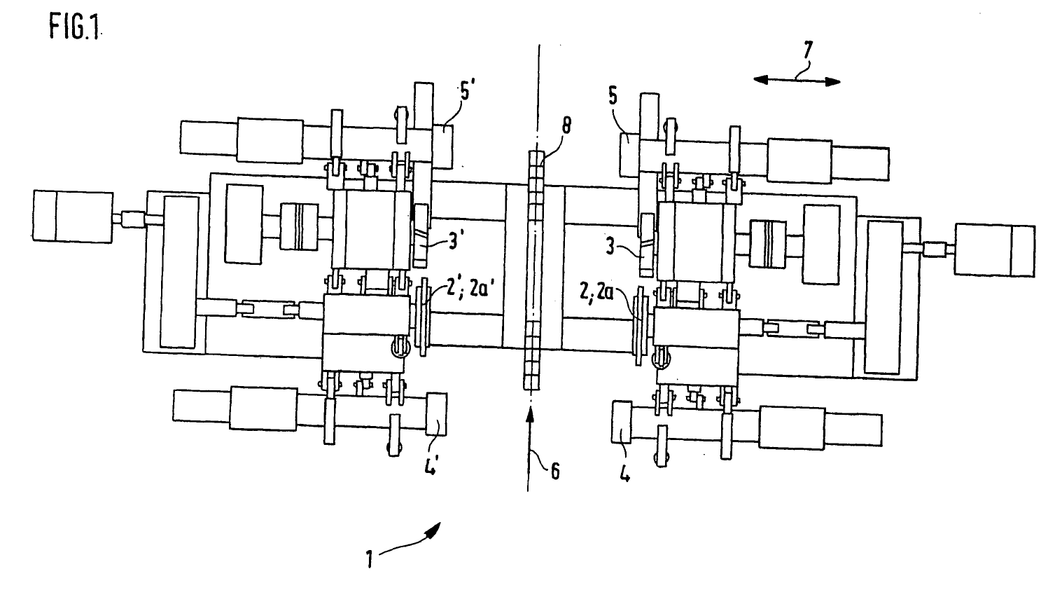

FIG. 1 shows a plan view of the device according to the invention for trimming the edges on both sides of rolled strips and/or sheets with twin edge-trimming shears, edge strip-cutting shears, and two pairs of driver rolls, one at the entrance, the other at the exit;

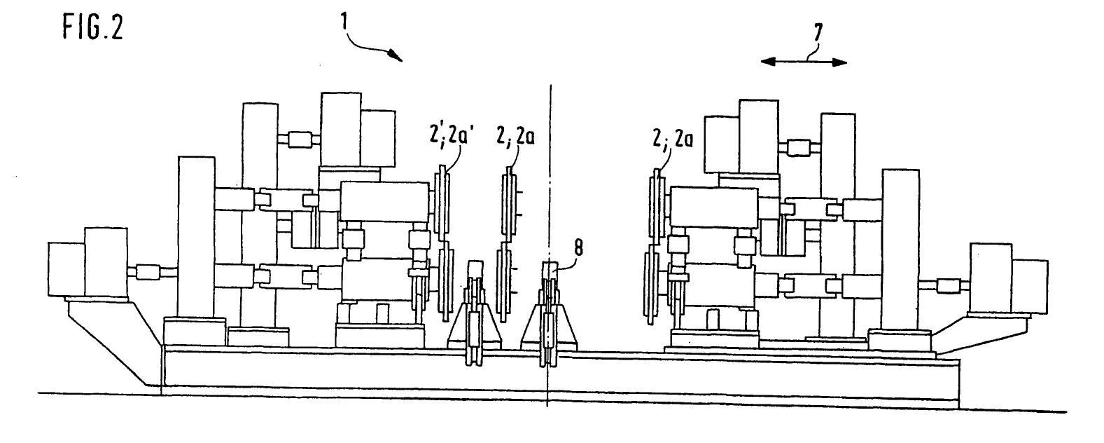

FIG. 2 shows a side view of the device according to the invention; and

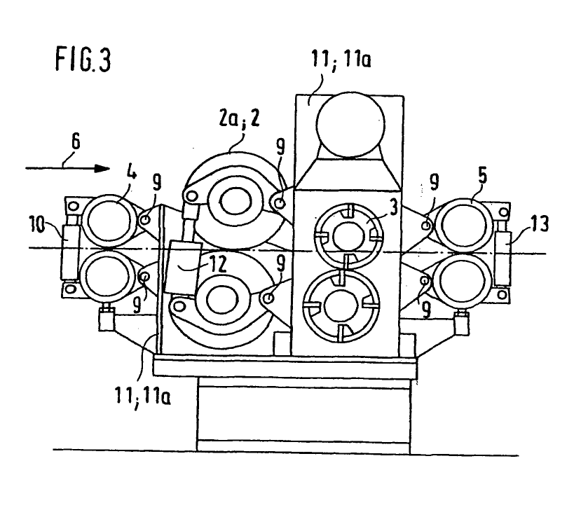

FIG. 3 shows a schematic, enlarged view of one side of the device according to the invention.

FIGS. 1 and 2 of the drawing show a front view and a side view, respectively, of a device 1 such as that used for trimming the two edges of rolled strips or sheets. One side of the device 1 is stationary, whereas the other side is able to move horizontally, as indicated by the double arrow 7, as a result of which it is possible to adjust the machine to the width of the product(s) to be trimmed.

The travel direction of the product(s) to be trimmed is indicated by the arrow 6. The pair or driver rolls 4, 4′ at the entrance feeds the product(s) to be trimmed to the rotary shears 2a, 2a′, which cut off a strip from each edge of the product(s) to be trimmed; these edge strips are sent directly to the edge strip-cutting shears 3, 3′. The edge strip-cutting shears 3, 3′ cut the separated strip into pieces of scrap suitable for charging. The pair of driver rolls 5, 5′ at the exit goes into action after the edge-trimming cuts have been made; that is, the exit pair 5, 5′ of driver rolls acts on the product(s) to be trimmed in synchrony with the entrance pair 4, 4′.

Support rolls 8 are provided to support the center of the product(s) to be trimmed. These can be shifted horizontally in accordance with the width of the product(s) to be trimmed and thus prevent the rolled strip from sagging in the middle.

The dash-dot line in FIG. 3 of the drawing represents the line along which the rolled strip travels. The direction of travel is indicated by the arrow 6.

The entrance pair 4 of driver rolls is connected by pivot points 9 to the base frame 11. So that rolled strip of different thicknesses can be accommodated, the gap between the lower driver roll and the upper driver roll can be adjusted by a hydraulic cylinder 10. This ensures that the pair of driver rolls 4 can provide the necessary feed without slipping. The pair of driver rolls 4 sends the rolled strip to the rotary shears 2a. The rotary shears 2a are connected to the base frame 11 above and below the strip by way of pivot points 9. Accommodation to rolled strip of different thicknesses can be accomplished by means of a hydraulic cylinder 12, which changes the position of the upper rotary blade.

The edge strip which has been cut off is sent directly to the edge strip-cutting shears 3.

The exit driver rolls 5 are mounted on the base frame 11 above and below the strip via pivot points 9. In the same way as at the entrance, synchronous adaptation to the thickness of the rolled strip is accomplished here as well by means of a hydraulic cylinder 13, which acts directly on the exit pair 5 of driver rolls.

In the claims:

1. (Amended) Device for trimming the two edges of rolled strips and/or sheets with twin edge-trimming shears, each of which has its own edge strip-cutting shears, the edge strip-cutting shears being installed under the edge-trimming shears in a position offset from the line of travel of the product(s) to be trimmed, the device also being provided with a pair of driver rolls at the entrance to, and another pair at the exit from, the twin edge-trimming shears, characterized in that wherein each edge-trimming shears (2, 2′), each edge strip-cutting shears (3, 3′), and each pair (4, 4′; 5, 5′) of driver rolls are combined on at least one base body (11, 11′); in that one base body (11, 11′) is stationary; and in that the other base body (11, 11′) is designed so that it can be moved and then fixed in position to accommodate different trimming widths of the rolled strip and/or sheet.

2. (Amended) Device according to claim 1, characterized in that wherein the edge-trimming shears (2, 2′) are designed as rotary shears (2a, 2a′).

3. (Amended) Device according to claim 1 and claim 2, characterized in that claim 1, wherein the base body (11, 11′) is designed as an open frame (11a, 11a′).

4. (Amended) Device according to one of claims 1-3, characterized in that claim 1, wherein the edge-trimming shears (2, 2′) and the pairs of driver rolls (4, 4′; 5, 5′) can be movably attached to the frame (11a, 11a′) at pivot points (9, 9′).

5. (Amended) Device according to one of claims 1-4, characterized in that claim 1, wherein the pairs of driver rolls (4, 4′; 5, 5′) attached movably to the frame (11a, 11a′) and the rotary shears (2a, 2a′) can be adjusted in a continuously variable manner by hydraulic cylinders (10, 10′; 12, 12′; 13, 13′) to accommodate the thickness of the product(s) to be trimmed.

6. (Amended) Device according to one of claims 1-5, characterized in that claim 1, wherein the rotary shears (2a, 2a′), the pairs of driver rolls (4, 4′; 5, 5′), and the edge strip-cutting shears (3, 3′) can be driven, and in that the drives can be synchronized with each other.

7. (Amended) Device according to one of claims 1-5, characterized in that claim 1, wherein the rotary shears (2a, 2a′) can be driven, and in that the pairs of driver rolls (4, 4′; 5, 5′) and the edge strip-cutting shears (3, 3′) can be connected by mechanical transmission gearing to the drive of the rotary shears (2a, 2a′).
